(19) United States
(12) Patent Application Publication
(10) Pub. No.: US 2009/0157591 A1
(43) Pub. Date: Jun. 18, 2009

(54) Methods for requesting specific content and delivering specific content based upon interests of multiple participants

(76) Inventor: Lucas Huff Scanlon, (US)

Correspondence Address: BETHANY KENNEDY SCANLON, 9757 PINE LAKE DRIVE #2004, HOUSTON, TX, 77055, US

(21) Appl. No.: 11/942,466

(22) Filed: Dec. 17, 2007

(51) Int. Cl. G06F 17/30

(52) U.S. Cl. 707/1; 707/E17.005

(57) ABSTRACT

Systems and methods for connecting two or more individuals through an internet web portal based on their mutual interests, allowing one participant to request specific content from another participant in the form of video, audio, text or image formats. This request content method allows for specific content to be exchanged without normal limitations of being in the same place at the same time. The content is specific to the requirements of the content request. The content For example, a participant can request content from another participant in a subject area in which the second participant is more skilled than the first. This allows for exchange of valuable information, such as is common to private lessons in music or other forms of art. The content exchange can be free or entail a payment for said content, at the discretion of the participant who will provide the content.

### BACKGROUND OF THE INVENTION

1. Field of Invention

This invention generally relates to internet based content, specifically to improved methods of requesting and delivering specific content between individuals based upon mutual interests and levels of trust between participants.

2. Prior Art

Previously in the area of music lessons, a student would discover they needs to input of a specific teacher regarding a specific area. The teacher would then either accept or reject the request made by the student, and then the teacher would decide whether or not to charge the student for the input exchanged. This method of transferring information required that both parties be in the same room at the same time, exchanging information and refining skill sets. These normal limitations prevent students from different parts of the world from exchanging information with preferred teachers in a controlled format.

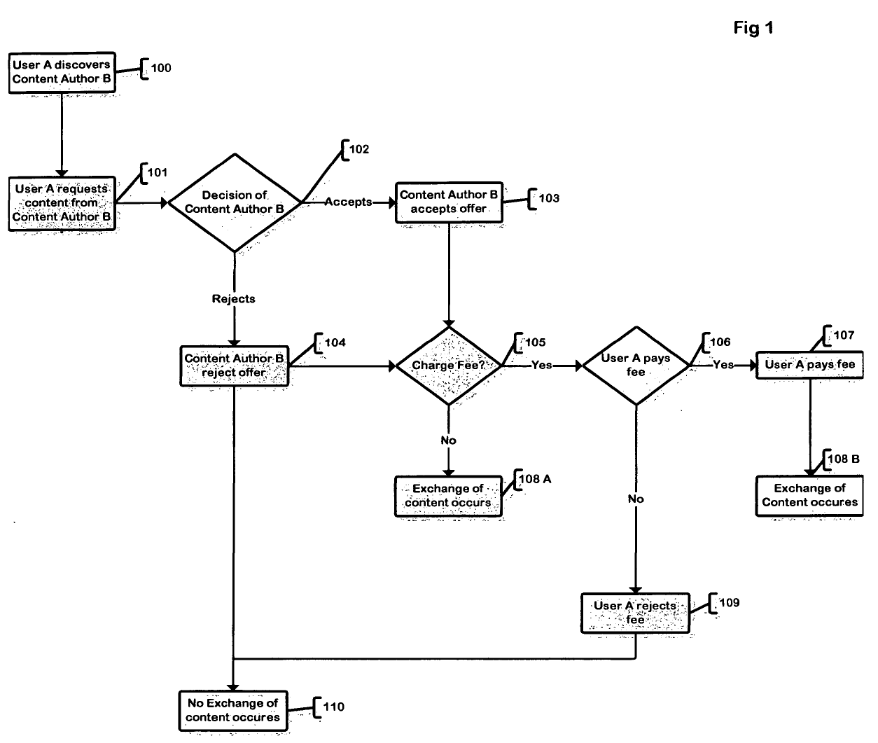

FIG. 1 describes this process. One embodiment of this process occurs when music lessons transpire. The student must locate the teacher with the correct skill sets (number 100), and then the student requests a lesson of said teacher (number 110). The teacher will then decide whether or not to accept the offer (number 120), and then whether or not to charge the student for the lesson (number 150). The student will then decide to accept or reject the offered price for the lesson (number 160), and then the lesson occurs is said teacher charges for said lesson and said student pays said teacher said offered price.

This practice limits the exchange of information because of normal limitations of time and distance.

### SUMMARY

In accordance with one embodiment, this current invention allowing for the exchange of content through a web portal that allows for a User A to locate a Content Author B and requesting content wherein the Content Author B and User A can negotiate an exchange of content free of normal limitations of time and geographic location.

The structural components to the system of the present invention include: a Payment Portal Processor; an Information Management Web Portal (hereafter IMWP) that manages video, text and image content and search functions; the existing EFT networks; and a credit and/or debit card. The Payment Portal Processor (PPP) is a software application that augments any Internet browser with e-commerce capability. An example of a PPP is Pay Pal which can be examined by placing the URL address (www.paypal.com) in a web browser and clicking “return” on the keyboard of the computer apparatus. The PPP software sits in front of and provides a secure portal for accessing (linking to) the user's Demand Deposit Accounts (DDA) and IPA accounts. The PPP enables the user to push electronic credits from its DDA and IPA accounts to any other accounts through the EFT network.

In one embodiment of the present invention, both User A and Content Author B create an account with IMWP, User A locates Content Author B via a search for specific content provided by the IMWP, User A finds content of Content Author B and chooses to request specific content from Content Author B, wherein Content author B and User A can exchange information that is personal to the request of User A. Both Content Author B and User A supply the PPP with their credit card numbers. The PPP contacts the credit card issuer authorization for the credit in the amount of the payment. When the authorization is returned, the EFT credit to the PPP account of the Content Author B is funded from the funds deposited in the PPP account of User A.

### DRAWINGS

### Figures

FIG. 1 is a representation of the current practice of content exchange.

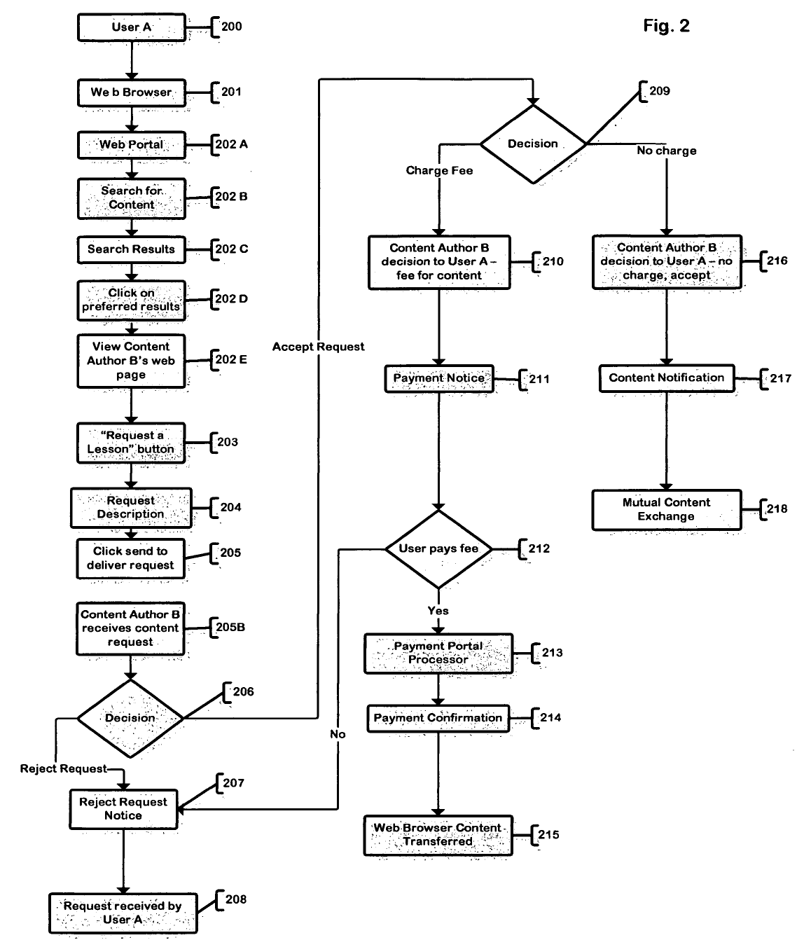

FIG. 2 is the current invention, demonstrating request of content through web portal.

### DETAILED DESCRIPTION

### First Embodiment

In contrast to existing method of exchanging information through discussion or demonstration, FIG. 2 demonstrates how User A will use a web portal to search for desired content and request an exchange of said content. When User A access a web browser (number 201) through a common computer and can find a web portal that manages information (number 202), User A will be able to search for desired content by keyword (202 B) using common search capabilities found in web applications such as those provided by Google (www.google.com).

The IMWP will return to User A search results (number 202 C) that reflect the keyword search User A originally performed. User A will then select content (number 202 D) that most closely matches the search that User A performed by clicking on the content's icon or text link (number 202 D). The web portal will then render Content Author B's content repository. From that web page, User A will then request specific content from Content Author B (number 204).

User A will request specific content from Content Author B through the web portal. User A will input through a keyboard common to commercially available computers a typed request description (number 204) for content regarding the (1) subject matter of the content; (2) the preferred format for the requested content (text, video, image or audio) and (3) background of the needs of User A. User A will then click a button (number 205 A) within the web portal to deliver the request to Content Author B.

Content Author B will then receive the request through the web portal (number 205 B). Content Author B will then decide to either accept or reject the request for specified content (number 206). If Content Author B chooses to deny the request, then Content Author B will click on a button in the web portal to reject the content request (number 207). The request rejection message will then be returned to the content repository of User A (number 208).

If Content Author B chooses to accept the request, then Content Author B will then decide to either charge User A for the content exchange (number 210) or not charge User A (number 216). Content Author B will then click on a button within the web portal to send a message to User A regarding no payment required (number 216) or that payment will be charged with the amount of payment within the message (number 210).

User A will then either accept the fee charged for content exchange (number 212) or they will not accept the charge for content exchange. If User A accepts charge then User A will enter into the PPP and deposit funds to pay the fee for the content exchange (number 213). Payment to Content Author B will be confirmed by Content Author B (number 214), and User A and Content Author B will participate in content exchange.

### CONCLUSION, RAMIFICATIONS, AND SCOPE

Accordingly the reader will see that, according to one embodiment of the invention, I have provided a format to allow for content exchange that eliminates the need for User A and Content Author B to exchange information at the same time or in the same geographic space. Content can also be exchanged that is specific to the requests of User A. Said content can be customized to the format appropriate for said content (text, video, image or audio) or dictated by the request of User A.

For example, if a student and teacher were to attempt to have a lesson, the student and teacher would no longer be bound by the limitations of time and geographic proximity. The student can request lesson material through said web portal and the teacher can accept or deny the request, pay a fee or not charge for the lesson. This promotes learning and facilities the exchange of information in a customized format according to the needs of the students and capabilities of the teacher with no restrictions of time or physical location.

While the above description contains many specificities, these should not be construed as limitations on the scope of any embodiment, but as exemplifications of the presently preferred embodiments thereof. Many other ramifications and variations are possible within the teachings of the various embodiments. Thus the scope of the invention should be determined by the appended claims and their legal equivalents, and not by the examples given.

1. A method of requesting specific content from Content Author B through web portal, comprising:
a. providing database memory which is able to store data that renders display of internet web portal,
b. providing selection input means which a User A can use to input a function request,
c. providing database memory which is able to capture said function request and render said function request into an expression of action,
d. providing character input means which said User A can input specifications of content request for Content Author B,
e. Providing there is said memory to capture and transmit said specifications of content request to said Content Author B,
f. Providing display within said web portal that will render said content request specifications,
g. Providing selection input means which said Content Author B can input function request to respond to said content request,
h. Providing selection input which said content author can manipulate input of content that meets requirements of said content request from said User A,
i. Providing database memory which is able to store said content,
j. Providing function that can render said content to useable format to said User A in said display through said web portal,
whereby said display will display said content request originally requested by User A and delivered by Content Author B within specified format as requested by said User A or pertaining to optimal format as judged by said Content Author B through said web portal.
